(19) United States
(12) Patent Application Publication
(10) Pub. No.: US 2007/0044775 A1
(43) Pub. Date: Mar. 1, 2007

(54) Fuel saving heater for internal combustion engine

(75) Inventor: Naiqiang Dong, Nanjing (CN)

Correspondence Address: Lan Way, 327 S. San Gabriel Blvd., San Gabriel, CA, 91776, US

(73) Assignee: Lan Way and Rong Ying Lin

(21) Appl. No.: 11/590,033

(22) Filed: Oct. 31, 2006

(30) Foreign Application Priority Data
Jun. 8, 1983 (JP) JP58-96161A
Oct. 24, 1987 (JP) JP62-243959A
Aug. 23, 2000 (CN) CN2392923Y

(51) Int. Cl. F02G 5/00; F02M 27/00

(52) U.S. Cl. 123/549; 123/538; 123/557

(57) ABSTRACT

A fuel saving device powered by electrical energy from a battery in an automobile has many competitive advantages over its predecessors such as efficient operation, inexpensive price, compact size, safe use, easy installation, simple replacement, etc. The device may be disposed at any convenient position preferably as close to the engine as possible. The device is operative automatically without any necessary alteration or modification to the original design of the automobile. The device has a housing means that further defines an inner chamber, inlet end, and outlet end. An infrared annular member made of heat retaining materials is disposed in the center portion of the inner chamber. A spirally electrical heating pipe, made of heat conductive materials, wraps firmly around the outside surface of the annular member. Within the heating pipe, there are not only stuffing gauzes with thermally conductive, electrically insulating nature, but also at least two sets of electrical heating elements. The heating elements are to generate sufficient heat to elevate the temperature for the heating pipe, the annular member, and filling metal gauzes stuffed within the inner chamber. All of aforesaid three heat exchangers are then to elevate the temperature of the fuel via thermal conduction by means of direct contact. Multi-elements plates within the inner chamber are to restore the fuel back to the original stage at refinery level without bad influences of fuel additives. An electrical system including a temperature sensor to detect the fuel temperature is to precisely control the flow of the electrical current from the battery to the heating elements. A fuel stabilizer is also provided to constantly balance the amount and the pressure of the fuel in order to prevent unnecessary fuel waste for the engine.

### BACKGROUND OF THE INVENTION

1. Field of the Invention

The invention generally relates to an internal combustion engine in an automobile, and specifically to an electrical fuel saving device for heating, catalyzing, and stabilizing the fuel flowing from a fuel tank in the automobile in order to maintain fuel temperature within a predetermined range, improve fuel quality, and prevent excessive fuel pressure to be delivered to the engine for efficient combustion.

2. Description of Prior Art

It is a well-known fact in automobile industry that hydrocarbon fuels such as gasoline and diesel are more efficiently burned for an internal combustion engine if their temperatures can be elevated and maintained within an optimum range than ambient temperatures at various weather conditions prior to intended combustion. To improve the fuel efficiency significantly, many engineers in prior arts have designed numerous devices trying to elevate the temperatures of the fuels above their ambient ones via three types of heat exchange media such as electricity, coolant, or exhaust gas in an automobile. The media of the coolant and the exhaust gas normally need the engine running for a longer time than the electricity medium especially in cold climate to release sufficient heat for the purpose of heating the fuels. Furthermore, both media may sometimes inevitably overheat the fuels to some extent so that the automobile is to be exposed to a great danger of fire or explosion should fuel leakages out of the fuel pipe of the automobile occur in an accident. The electricity seems to be the most feasible and reliable medium to elevate the fuel temperatures for the engine if it is not to cause substantial burden on the battery of the automobile.

Although many heating devices of the prior arts have proved to be operationally efficient in fuel saving for engines of automobiles, these devices definitely have attendant disadvantages in accompanying with the mere advantage of the fuel efficiency. The disadvantages, namely expensive price, bulky size, difficult installation, complex design, hard replacement, and unsafe use, apparently do not thus far justify for their widespread adoptions or usages by either automobile manufacturers or general public.

### OBJECTS OF THE INVENTION

It is a main object of the present invention to provide an improved fuel heating device for an internal combustion engine in an automobile which is efficient in operation, inexpensive in price, compact in size, safe in use, easy in installation, simple in replacement, etc.

It is a further object of the present invention to provide a fuel heating device for the engine which can be readily retrofitted on all types and models of automobiles.

It is a further object of the present invention to provide a fuel heating device for the engine which is capable of accurately maintaining the temperature of the fuel to be delivered to a carburetor or a fuel injector in the automobile within a predetermined range below the boiling point of the fuel but substantially above the ambient temperature at various weather conditions.

It is a further object of the present invention to provide a fuel heating device for the engine which includes a built-in stabilizer capable of regulating the flow and the pressure of the fuel to prevent both from reaching to an excessive or even harmful level.

It is a further object of the present invention to provide a fuel heating device, which can be disposed at any convenient position for the fuel pipe between a fuel tank and the carburetor or fuel injector in the automobile, and be utilized by the engine without any alteration or modification to the original design of the automobile.

The invention will be further understood and additional objects and advantages will become apparent from a consideration of the ensuing description and drawings.

### SUMMARY OF THE INVENTION

This invention relates to a fuel heating device in which a housing means defines an inlet end, inner chamber, and outlet end to allow the fuel from a fuel tank in an automobile to be heated and then be delivered to an internal combustion engine for efficient burning. In the center portion of the inner chamber, there is an infrared annular member that further defines an interior passageway for some fuel passing through from the inlet end to be heated within. The annular member, made of heat retaining materials, is elongated in shape with its most part in small dimension at size near the inlet end and the remaining part in large dimension at size near the outlet end. On the outside surface of the annular member, there is sintered with a multi-metallic layer. The layer can enhance the temperature stability in the inner chamber by gradually releasing the heat of the annular member slowly. Wrapping around the outside surface of the annular member with small size, there is a spirally electrical heating pipe that is made of heat conductive materials. Besides the aforementioned annular member and heating pipe, there are still multi-elements plates and filling metal gauzes within the inner chamber. The multi-elements plates may be disposed near the inlet end or the outlet end within the inner chamber. Both of the plates and the aforesaid layer are able to perform a catalysis process to improve the quality of the fuel by restoring the fuel back to the original stage at refinery level without bad influences of fuel additives. Within the heating pipe, two or more sets of electrical heating elements and stuffing gauzes primarily made of magnesium oxide are provided to generate and conduct sufficient heat to elevate and maintain the temperatures of the heating pipe, the annular member, and the filling gauzes. On the outer surface of the heating pipe, there is sprayed with a nanometer-level ceramic coating to prevent the fuel in direct contact with the surface from overheating. A temperature sensor, connected to a thermocouple transducer, is furnished near the outlet end to detect the fuel temperature. The transducer is further connected to a control circuit, semiconductor controllers, and a thermistor that are able to actuate, adjust, and interrupt the electrical current from the battery to the heating elements to prevent the fuel from overheating and unsafe incidents from happening. A fuel stabilizer, disposed against the inner walls of the inlet end, able to regulate the amount and the pressure of the fuel flowing from the fuel tank in the automobile to a constantly balancing level upon its exiting out the device is also supplied.

### BRIEF DESCRIPTION OF THE DRAWINGS

Additional objectives, features, and advantages of the present invention will be apparent from the following detailed description and appended claims in conjunction with accompanying drawings, and like reference numerals designate like parts and elements throughout all figures in the drawings, wherein

FIG. 1 is a sectional view of a fuel saving device showing all principal parts in accordance with the present invention.

FIG. 2 is a sectional view of a fuel stabilizer showing all principal parts in accordance with the present invention.

FIG. 3 is an outline of an electrical system for the present invention.

### DETAILED DESCRIPTION OF THE PREFERRED EMBODIMENT

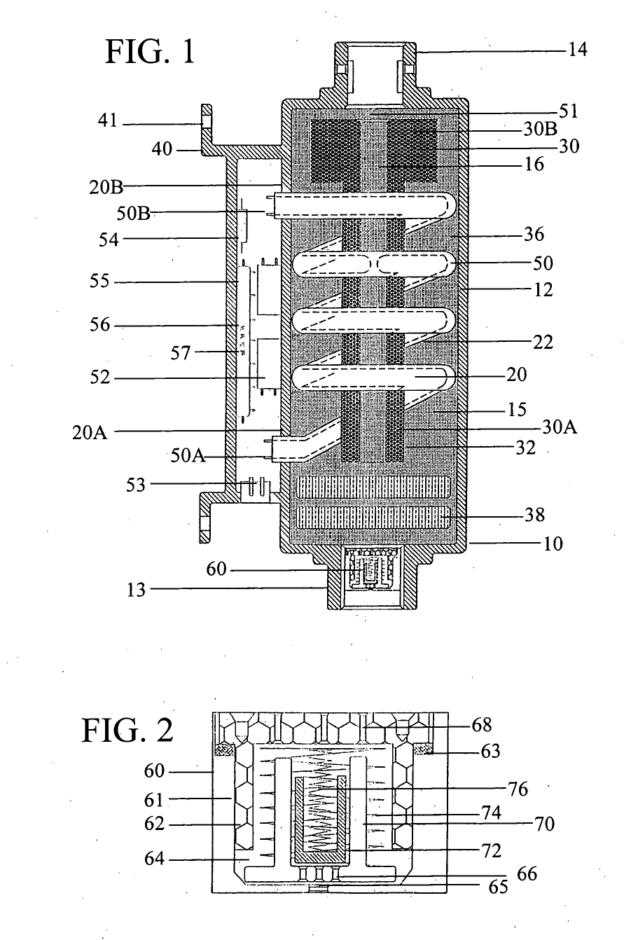

With particular reference to FIG. 1, a fuel saving device 10 in accordance with the preferred embodiment of the present invention comprises of an elongated housing means 12 with an inlet end 13 at its one side and an outlet end 14 at its other side, and a holding base 40 beneath it to be installed on any convenient position in an automobile preferably as close to an internal combustion engine (not shown) as possible. The housing means 12 further defines an inner chamber 15 along with the inlet end 13 and the outlet end 14 for establishing a flow of the fuel from a fuel tank (not shown) to the engine with the device 10 in between. There is an infrared annular member 30 disposed in the center portion of the inner chamber 15 between the inlet end 13 and the outlet end 14. The annular member 30 elongated in shape can be divided into two different parts. The large part is in small dimension at size 30A with its one side situated near the inlet end 13. The small part is in large dimension at size 30B with its one side situated near the outlet end 14. The annular member 30, made of heat retaining materials, further defines an interior passageway 16 for the fuel passing through it to be elevated in temperature. The housing means 12 mounted on the round base 40 is furthermore fixed securely by a plurality of installation holes 41 on any convenient position between the fuel tank and the engine by means of fastening means (not shown) like screws or bolts. A thermistor 54, an electrical connector 53, and an electrical circuit board 55 with semiconductor controllers 56 and a control circuit 57 on it that connect and control the electrical current from the battery are all mounted on the base 40.

Wrapping closely and snugly around the outside surface of the annular member 30 with small size 30A, there is a spirally electrical heating pipe 20. The heating pipe 20, made of heat conductive materials, enters into the housing means 12 from an entering position 20A near the inlet end 13 and exits out the housing means 12 from an exiting position 20B near the outlet end 14. The major purpose for the heating pipe 20 to wrap around the annular member 30 spirally in the inner chamber 15 is to provide intended thermal conduction from the heating pipe 20 to the annular member 30. The minor purpose to wrap around the annular member 30 spirally is to hold the annular member 30 in a stable position within the inner chamber 15. Both of the entering position 20A and the exiting position 20B of the heating pipe 20 are fixed and sealed firmly with the housing means 12 by threaded engagements (not shown) to prevent unnecessary fuel leakages. Two or more sets of electrical heating elements 50, made of positive temperature coefficient of resistance materials and regulated by the thermistor 54 on the base 40, are disposed within the heating pipe 20. Both the heating elements 50 and thermistor 54 are connected with the battery to deliver the electrical energy actuated by an ignition switch (not shown) of the automobile to the device 10. All sets of the heating elements 50 are adjoined and insulated each other and/or one another all the time within the heating pipe 20 to safely ensure thermal conduction to the outer surface of the heating pipe 20 evenly and uniformly.

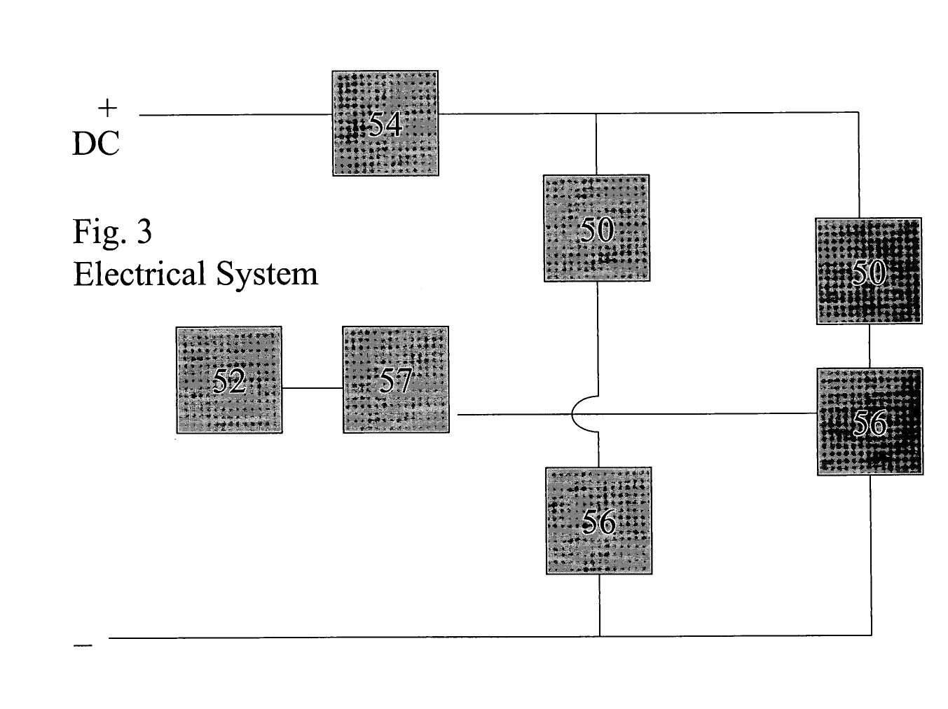

With particular reference to FIGS. 1 and 3, when the ignition switch of the automobile is turned on, a temperature sensor 51 near the outlet end 14 often detects a lower fuel temperature at ambient surroundings especially in cold weather than the temperature range predetermined by the optimum combustion for the engine. The sensor 51 is then to send an electronic signal to a thermocouple transducer 52 disposed beneath the housing means 12. The control circuit 57, connected to the transducer 52, the electrical connector 53, the controllers 56, and the thermistor 54, on the circuit board 55 is to actuate the electrical current throughout all sets of the heating elements 50 to elevate the fuel temperature rapidly. As soon as the sensor 51 detects the fuel temperature reaching one-half degree Fahrenheit above the preset optimum range, the control circuit 57 under the instruction of the controllers 56 is to interrupt the electrical current throughout all sets of the heating elements 50 except one to prevent the fuel from overheating. This only set of the heating elements 50A not interrupted by the control circuit 57 has been continuously working to maintain the fuel temperature within the preset optimum range so long as the ignition switch is on. As soon as the sensor 51 detects the fuel temperature dropping one-half degree Fahrenheit below the preset optimum range, the control circuit 57 under the instruction of the controllers 56 is to actuate the electrical current throughout all other sets of the heating elements 50B to elevate the fuel temperature again. The transducer 52 functions as a liaison among the sensor 51, the control circuit 57, the controllers 56, the thermistor 54, and the heating elements 50 to constantly actuate, adjust, or interrupt the electrical current from the battery to an accurate extent in accordance with the fuel temperature detected by the sensor 51. The transducer 52 currently mounted beneath the housing means 12 and the thermistor 54 currently mounted on the base 40 described above may be disposed on the circuit board 55 instead.

Besides the space occupied by the heating elements 50, there are filled with thermally conductive, electrically insulating stuffing gauzes (not shown) within the heating pipe 20. The stuffing gauzes primarily made of magnesium oxide can hold all sets of the heating elements 50 in firm and stable positions. The stuffing gauzes virtually serve two purposes: one for a thermal conduction medium between the heating elements 50 and the heating pipe 20 and another for electrical insulation among all sets of the heating elements 50. On the outer surface of the heating pipe 20, there is sprayed with a nanometer-level ceramic coating 22 to prevent the fuel in direct contact with the surface from overheating. The ceramic coating 22 practically works to lessen the extent of thermal conduction between the heating pipe 20 and the fuel touching the outer surface for safety concerns. On the outside surface of the annular member 30, there is sintered with a multi-metallic layer 32. The layer 32 can enhance the temperature stability in the inner chamber 15 by gradually releasing the heat of the annular member 30 little by little. The layer 32 also can activate a catalysis process of restoring the fuel back to the original stage at refinery level for efficient combustion before delivery to customers. The reason for the catalysis process to improve the combustion efficiency of the fuel is that all refineries usually add additives to the fuel for numerous reasons like safety, logistics, or antifreeze. Unfortunately, these additives are not helpful or even harmful for the fuel to be burned efficiently in the engine. To further improve the quality of the fuel upon its initial entry into and final exit out the device 10, a plurality of multi-elements plates 38, made of catalysis materials used often by refineries, may be disposed within the inner chamber 15 near the inlet end 13 or the outlet end 14. Likewise to the stuffing gauzes filled within the heating pipe 20 besides the heating elements 50, there are filling metal gauzes 36 stuffed within the inner chamber 15 besides the annular member 30, the heating pipe 20, and the multi-elements plates 38. The filling gauzes 36 not only can absorb the heat diffused from the heating pipe 20 and the annular member 30 to elevate the fuel temperature by means of direct contract, but also can hold the annular member 30 in a stable position within the inner chamber 15.

With particular reference to FIG. 2, a fuel stabilizer 60 to regulate the flow and the pressure of the fuel to a constantly balancing level comprises a cup-shaped inlet casing means 61 and outlet casing means 62. Both are made of stiff materials and disposed against the inner walls of the inlet end 13 for the device 10. The cup-shaped inlet and outlet casing means 61, 62 are clamped 63 together to form an enclosure 64. The inlet casing means 61 further has an inlet orifice 65 in its center portion to allow the fuel from the fuel tank to enter into the stabilizer 60. The outlet casing means 62 further has a plurality of outlet apertures 68 in its center portion to allow the fuel passing through from the enclosure 64 to enter into the inner chamber 15 of the device 10. In the enclosure 64, there is a unshaped large piston 70 whose bottom portion is close and parallel to the inner wall of the inlet casing means 61. The large piston 70 has a plurality of inlet apertures 66 in its center portion to allow the fuel passing through from the inlet orifice 65 to enter into the enclosure 64 furthermore. In the meanwhile, these inlet apertures 66 may deny some of the fuel passing through from the inlet orifice 65 to enter into the enclosure 64 furthermore when the large piston 70 is moving toward the inlet casing means 61 to block some of the inlet apertures 66. There is a large compression spring 74 disposed and extended between the large piston 70 and the outlet casing means 62 in the enclosure 64. Its one side is attached to the inner wall of the large piston 70, whereas its other side to the inner wall of the outlet casing means 62. The compression spring 74 is to provide a restraining force to push the large piston 70 toward the inlet casing means 61 and then to block the flow of some fuel from the inlet orifice 65 to enter into the enclosure 64 furthermore. There is also a unshaped small piston 72 disposed in the pocket of the large piston 70 in the enclosure 64. The bottom portion of the small piston 72 is close and parallel to the bottom portion of the large piston 70. There is a small tension spring 76 disposed and extended between the small piston 72 and the outlet casing means 62 in the enclosure 64. Its one side is attached to the inner wall of the outlet casing means 62, whereas other side to the inner wall of the small piston 72. The tension spring 76 is to provide a restraining force to push the small piston 72 toward the large piston 70 and then to block the flow of the fuel from the inlet apertures 66 to enter into the enclosure 64 furthermore. The stabilizer 60 fully utilizes both restraining forces from the compression spring 74 and the tension spring 76 in accompanying with the moving function of large piston 70 and small piston 72 to block the flow of some fuel in order to achieve a constantly balancing level for the amount and the pressure of the fuel passing through it.

### OPERATION OF THE INVENTION

The preferred embodiment of the fuel saving device 10 described and depicted above can be moreover delineated from the standpoint of its operation. When an ignition switch (not shown) of an automobile is turned on, the battery of the automobile is to provide electrical current to all sets of heating elements 50. The heating elements 50, made of heat resistant materials and controlled by a thermistor 54 on a holding base 40, are disposed within a spirally electrical heating pipe 20 to avoid direct contact with the fuel from a fuel tank (not shown) for safety reasons. To further prevent the fuel from overheating caused by any direct contact, there is a ceramic coating 22 sprayed on the outer surface of the heating pipe 20. The heating pipe 20, made of heat conductive materials, enters into a housing means 12 from its one position 20A and exits out the housing means from its other position 20B. The heating elements 50 are to rapidly elevate the temperature of the heating pipe 20 first and then in turn to elevate ones of an infrared annular member 30 and filling metal gauzes 36 via thermal conduction in an inner chamber 15 defined by the housing means 12. The fuel at ambient temperature furnished by a fuel pump (not shown) flows into the device 10 from an inlet end 13. The temperature of the fuel is to be elevated by the heating pipe 20, the annular member 30, and the filling gauzes 36 in the inner chamber 15 by means of thermal conduction while the fuel is passing through the device 10. Before the fuel finally exits out the device 10 from an outlet end 14, there is a temperature sensor 51 to detect the fuel temperature. Should the fuel temperature is above or below a preset optimum range, an electronic signal from the sensor 51 is sent to a thermocouple transducer 52 beneath the housing means 12 and a control circuit 57 on an electrical circuit board 55. Both of the circuit board 55 and the thermistor 54 are mounted on the base 40 on which further holds the housing means 12 of the device 10. The control circuit 57 under the instruction of semiconductor controllers 56 on the circuit board 55 is to actuate, adjust, or interrupt electrical current to all sets of the heating elements 50 except one. This very set of the heating elements 50 is to be continuously working to prevent the fuel temperature dropping below the preset optimum range as long as the ignition switch is on. The device 10, able to elevate and maintain the fuel temperature accurately and safely within the preset optimum range, consequently results into two favorable effects: the improvement in fuel efficiency and the reduction in emitting pollutants. The device 10 is also able to improve the quality of the fuel moreover by providing a multi-metallic layer 32 on the outside surface of the annular member 30 and multi-elements plates 38 within the inner chamber 15. Both are capable of restoring the fuel back to the original stage at refinery level for the efficient combustion in the engine. The device 10 finally provides a fuel stabilizer 60 to regulate the amount and the pressure of the fuel to a constantly balancing level to avoid any unnecessary fuel waste in the engine.

Accordingly, while this invention has been described with reference to the illustrative embodiment, none should intend to interpret the description in a limiting or narrow sense regarding its scope. Various ramifications, variations, and modifications of the illustrative embodiment will be apparent to those people skilled in the art upon reference to the description. It is therefore contemplated that the appended claims and their legal equivalents will cover any aforesaid ramifications, variations, and modifications within the true scope of the invention.

I claim:

1. A fuel saving device to elevate the temperature of a fuel for an internal combustion engine of an automobile, comprising:
a) a housing means made of rigid materials defining an inner chamber, said housing means defining an inlet end connected to a fuel pipe from a fuel tank and an outlet end connected to a fuel injector or carburetor for establishing a flow of fuel from said inlet end to said outlet end via said inner chamber,
b) an infrared annular member, made of a heat retaining material and disposed in the center portion of said inner chamber, having an interior passageway mainly for elevating the temperature of said fuel passing through, and
c) a spirally electrical heating pipe, made of a heat conductive material and wrapped securely around said annular member, having a plurality of electrical heating elements within it for elevating the temperature of said heating pipe and said annular member.
Whereby said annular member and said heating pipe are to work jointly for elevating the temperature of said fuel passing through from said inlet end, said inner chamber, and said outlet end to achieve dual goals of fuel efficiency and pollution reduction for said automobile.

2. A fuel saving device according to claim one, wherein at least two sets of said heating elements within said heating pipe which enters into said housing means from one position and exits out said housing means from the other position, each set of said heating element entering into said housing means from said entering position of said heating pipe individually and exiting out said housing means from said exiting position of said heating pipe respectively, and all sets of said heating elements within said heating pipe being biased and insulated.

3. A fuel saving device according to claim one, said heating pipe further having stuffing gauzes within primarily made of magnesium oxide with heat-conductive and electricity-insulating nature.

4. A fuel saving device according to claim one, said heating pipe further including a nanometer-level ceramic coating sprayed on its outer surface to prevent said fuel from overheating.

5. A fuel saving device according to claim one, said annular member further including a multi-metallic layer sintered on its outside surface to restore said fuel back to the original stage at refinery level before delivery to customers for efficient combustion.

6. A fuel saving device according to claim one, further including a holding base on which said housing means is mounted for said automobile.

7. A fuel saving device according to claim one, further including a temperature sensor operative to detect the temperature of the fuel, the outlet of said sensor connected with the inlet of a control circuit, the outlet of said control circuit connected with semiconductor controllers, and each said controller connected with a battery in said automobile for actuating and interrupting electrical current to each said heating element individually.

8. A fuel saving device according to claim one, further including filling metal gauzes and multi-elements plates disposed within said inner chamber, said filling gauzes able to perform thermal conduction and hold said annular member in a stable position, and said plates able to restore said fuel back to the original stage at refinery level before delivery to customers for efficient combustion.

9. A fuel saving device according to claim one, wherein being suitable for all types of fuels:
regular gasoline, premium gasoline, ethanol gasoline, methanol gasoline, diesel fuel, emulsified fuel, and composite fuel.

10. A fuel stabilizer to regulate the flow and the pressure of said fuel to a constantly balancing level, comprising:
a) a cup-shaped inlet casing means and outlet casing means, both made of stiff materials and disposed against the two inner walls of said inlet end, clamped together for forming an enclosure, said inlet casing means further having an inlet orifice in its center portion to allow said fuel from a fuel tank to enter into said stabilizer, said outlet casing means further having a plurality of outlet apertures in its center portion to allow said fuel passing through from said enclosure to enter into said inner chamber in said housing means;
b) a u-shaped large piston in said enclosure, being close and parallel to the inner wall of said inlet casing means, having a plurality of inlet apertures normally to permit said fuel passing through from said inlet orifice to enter into said enclosure furthermore and sometimes to deny some of said fuel passing through from said inlet orifice to enter into said enclosure furthermore while said large piston is moving toward said inlet casing means to block some passage of said fuel from said inlet orifice;
c) a large compression spring, disposed and extended between said large piston and said outlet casing means, its one side attached to the inner wall of said large piston, whereas its other side attached to the inner wall of said outlet casing means for providing a restraining force to push said large piston toward said inlet casing means;
d) a u-shaped small piston in said enclosure, disposed in the pocket of said large piston, normally to permit said fuel passing through from said inlet apertures to enter into said enclosure furthermore and sometimes to deny some of said fuel passing through from said inlet apertures to enter into said enclosure furthermore while said small piston is moving toward said large piston to block some passage of said fuel from said inlet apertures;
e) a small tension spring, disposed and extended between said small piston and said outlet casing means, its one side attached to the inner wall of said outlet casing means, whereas its other side attached to the inner wall of said small piston for providing a restraining force to push said small piston toward said large piston.
